(19) United States
(12) Patent Application Publication
(10) Pub. No.: US 2023/0369876 A1
(43) Pub. Date: Nov. 16, 2023

(54) MICROCONTROLLER BASED SOLAR ARRAY ENERGY TRANSFER BATTERY CHARGE CONTROL

(71) Applicant: Maxar Space LLC, Palo Alto, CA (US)

(72) Inventors: Jason Esquivias, Aurora, CO (US); Lee Charles Rotlisberger, San Jose, CA (US); Jeffrey David McCallum, East Palo Alto, CA (US)

(73) Assignee: Maxar Space LLC, Palo Alto, CA (US)

(21) Appl. No.: 17/744,437

(22) Filed: May 13, 2022

(51) Int. Cl. H02J 7/00; H02J 3/38; B64G 1/66

(52) U.S. Cl. CPC H02J 7/007182; H02J 3/381; H02J 7/00032; H02J 7/0047; B64G 1/66; H02J 2310/44; H02J 2300/26

(57) ABSTRACT

Technology is disclosed herein for a power control and distribution unit (PCDU) of a spacecraft that has a microcontroller to control battery charging from solar arrays. Using a microcontroller within the PCDU reduces the complexity of the PCDU. The microcontroller may be programmable and reprogrammable, which allows the charging of the battery to be adapted to various conditions. For example, the microcontroller can be programmed in accordance with the mission to optimize battery charging for that mission.

### BACKGROUND

Spacecrafts such as satellites have power subsystems that include solar arrays and batteries. The solar arrays are used to provide power to the spacecraft and may also be used to charge the batteries. The batteries are thus able to provide power in the event the solar arrays are unable to such as during brief times when the orbit of the spacecraft results in an “eclipse.” For example, a satellite in a geosynchronous earth orbit (GEO) may have full sunlight throughout a 24 hour day except for two “eclipse seasons,” which occur at the vernal and autumnal equinoxes. An eclipse season could last for about 45 days, with daily eclipses having a duration of about an hour or less.

The spacecraft will typically have a power control and distribution unit (PCDU) that conditions and/or controls the power provided by the solar arrays and distributes the power to a load. The PCDU may also be responsible for charging the battery. Such PCDUs often require many electronic components, which adds to part count and space on electronic circuit boards of the PCDU. Also, in some cases the power regulation system in the PCDU is actually more complex than needed.

### BRIEF DESCRIPTION OF THE DRAWINGS

Aspects of the present disclosure are illustrated by way of example and are not limited by the accompanying figures for which like references indicate the same or similar elements.

FIG. 1 is a block diagram of a spacecraft system.

FIG. 2 is a diagram of one embodiment of an electronic power system (EPS) of a spacecraft.

FIG. 3A is a diagram of one embodiment of a DET architecture in which the energy from the respective solar array circuits is directly transferred to the main power bus.

FIG. 3B depicts an embodiment in which the PCDU has a PPT architecture.

FIG. 4 is diagram of one embodiment of a solar array circuit.

FIG. 5 is a flowchart of one embodiment of a process of charging a battery in a spacecraft.

FIG. 6 is a flowchart of one embodiment of a process of charging a battery in a spacecraft by a microcontroller within a PCDU having a DET architecture.

FIG. 7 is a flowchart of one embodiment of a process of the microcontroller determining how to control the current selection circuitry.

FIG. 8 is a flowchart of one embodiment of a flowchart of a process of controlling switches to achieve a target battery charging current.

FIG. 9 is a flowchart of one embodiment of a process of the microcontroller controlling battery charging based on battery charging parameters received from the main computer.

FIG. 10 is a flowchart of one embodiment of a process of the microcontroller varying the battery charging process based on changes to battery charging parameters.

FIG. 11 is a block diagram of an example spacecraft.

### DETAILED DESCRIPTION

Technology is disclosed herein for a PCDU of a spacecraft that has a microcontroller to control battery charging from solar arrays. Using a microcontroller within the PCDU reduces the complexity of the PCDU. The microcontroller may be programmable and reprogrammable, which allows the charging of the battery to be adapted to various conditions. For example, the microcontroller can be programmed in accordance with the mission to optimize battery charging for that mission.

Some conventional techniques use an analog error amplifier within the PCDU in order to control battery charging. It can be difficult to change battery charging procedures without a hardware change, which thereby either limits flexibility in battery charging or requires costly hardware changes. This difficulty is especially true for changing battery charging procedures for a spacecraft.

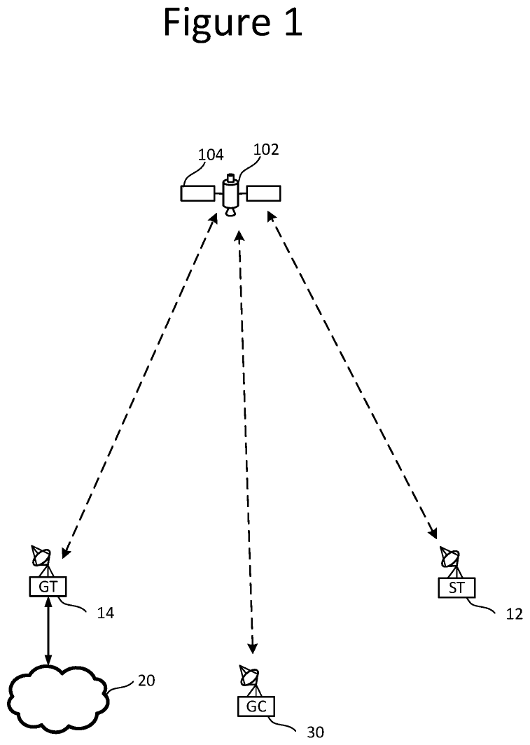

FIG. 1 is a block diagram of a spacecraft system. The system of FIG. 1 includes spacecraft 102, subscriber terminal 12, gateway 14, and ground control terminal 30. Subscriber terminal 12, gateway 14, and ground control terminal 30 are examples of ground terminals. In one embodiment, spacecraft 102 is a satellite; however, spacecraft 102 can be other types of spacecrafts. Spacecraft 102 may be in a mission orbit, such as a geostationary or non-geostationary orbital location. Spacecraft 102 has solar arrays 104 that generate electrical power, which may be used to power sub-systems and/or payloads. The spacecraft has one or more batteries, which may be used to power the sub-systems and/or payloads when the solar arrays 104 are not generating sufficient power. Technology disclosed herein may be used for recharging the batteries in the spacecraft 102 based on power from solar arrays 104. In an embodiment, the spacecraft 102 has a PCDU having a programmable and reprogrammable microcontroller that controls battery charging.

Spacecraft 102 is communicatively coupled by at least one wireless feeder link to at least one gateway terminal 12 and by at least one wireless user link to a plurality of subscriber terminals (e.g., subscriber terminal 12) via an antenna system. Gateway terminal 14 is connected to the Internet 20. The system allows spacecraft 102 to provide internet connectivity to a plurality of subscriber terminals (e.g., subscriber terminal 12) via gateway 14. Ground control terminal 30 is used to monitor and control operations of spacecraft 102. Spacecraft can vary greatly in size, structure, usage, and power requirements, but when reference is made to a specific embodiment for the spacecraft 102, the example of a communication satellite will often be used in the following, although the techniques are more widely applicable, including other or additional payloads such as for an optical satellite.

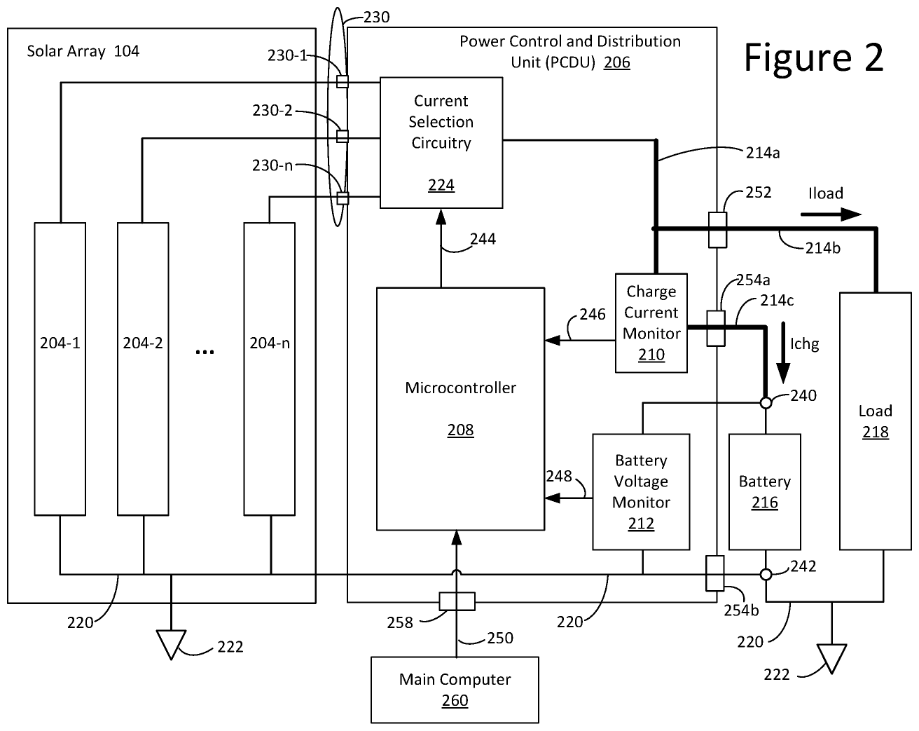

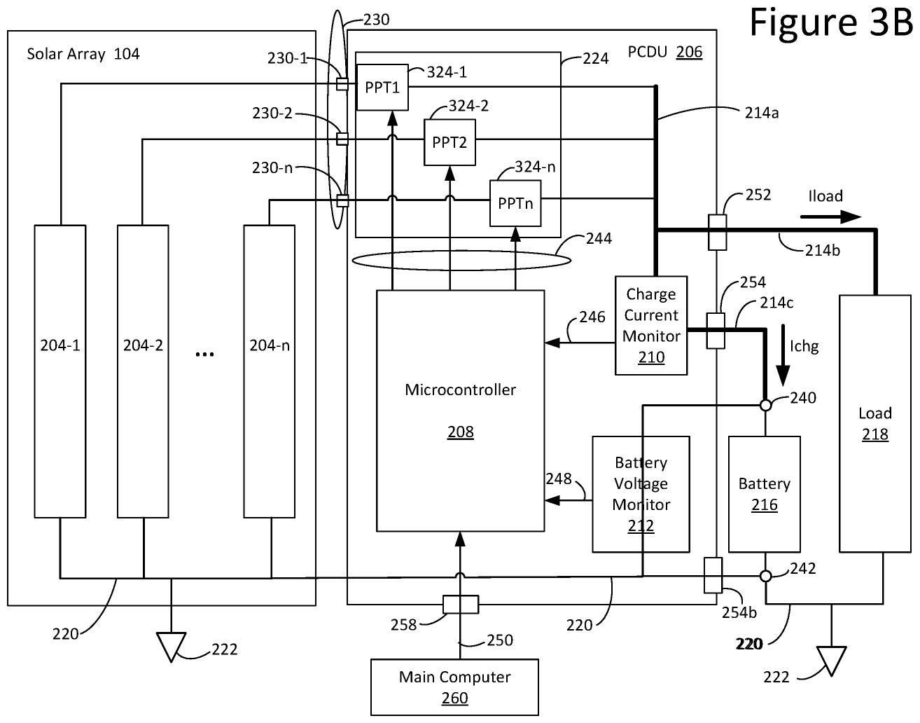

FIG. 2 is a diagram of one embodiment of an electronic power system (EPS) of a spacecraft 102. The EPS includes solar arrays 104, a Power Control and Distribution Unit (PCDU) 206, and a battery 216. The PCDU 206 receives power from the solar array 104 and distributes power to the load 218. The load 218 includes various sub-systems and/or payloads. The PCDU 206 is also responsible for charging the battery 216. The battery 216 is configured to store the power from the solar array 104 and supply the power to the sub-systems and/or the payloads when the solar power is not sufficient to meet power requirements. The solar array 104 has a number of solar array circuits 204-1, 204-2, . . . 204-n. Each solar array circuit 204 is able to generate power and/or current independent of the other solar array circuits 204. Each solar array circuit 204 contains one or more strings of photovoltaic (PV) cells, which will be discussed in more detail below in the discussion of FIG. 4. A solar array circuit 204 is a group of PV cells that may be selected as a unit to provide power. When a solar array circuit 204 is selected a closed circuit is formed to enable transfer of power from the solar array circuit 204.

The PCDU 206 provides power, voltage, and/or current to a main power bus. The main power bus has a positive line 214 and a negative (or return) line 220. The return line 220 is connected to ground 222. in an embodiment, the ground 222 is the body of the spacecraft 102. The positive line 214 has several different sections 214a, 214b, 214c referenced in FIG. 2. The reference numeral 214 may be used herein to refer to the positive line 214 in general. A portion of the positive line 214a is internal to the PCDU 206. A portion of the positive line 214b provides a load current (Iload) to the load 218. A portion of the positive line 214c provides a battery charging current (Ichg) to the battery 216. The battery 216 is connected between the positive line 214c and the return line 220 of the main power bus. Stated another way, the battery 216 is connected to the main power bus. The positive terminal 240 of the battery 216 is connected to the positive line 214c and the negative terminal 242 of the battery 216 is connected to the return line 220. Thus, in this embodiment, the voltage across the battery 216 is equal to the voltage across the main power bus. The voltage across the main power bus refers to the voltage between the positive line 214 and the return line 220 (or ground). In this manner, the battery voltage serves to regulate the voltage on the main power bus. Note that the voltage on the different sections of the positive line 214a, 214b, 214c is essentially the same, although there may be very small differences in voltage due to factors such as the resistance and/or capacitance of the positive line 214.

The load 218 is also connected between the positive line 214b and the return line 220 of the main power bus. The load 218 may include one or more sub-systems and/or one or more payloads. The main power bus provides power, voltage, and/or current (float) to the load 218. The PCDU 206 has a main power bus interface 252 that connects the internal positive line 214a to the external positive line 214b that connects to the load 218. Herein, the term “main power bus interface” may be used to refer to the interface to the internal main power bus that the PCDU 206 provides to the load 218. Note that the PCDU 206 will also have a connection to common ground 222 (or return line 220), wherein this connection may also be considered to be part of the main power bus interface.

The PCDU 206 has a microcontroller 208, a charge current monitor 210, a battery voltage monitor 212, a portion of the main power bus 214a, and current selection circuitry 224. The current selection circuitry 224 is connected between the solar array circuits 204 and the positive line 214a of the main power bus. The current selection circuitry 224 is controlled by the microcontroller 208, which sends one or more control signals on the control line(s) 244. The control signals may be digital or analog. The microcontroller 208 issues the one or more control signals to control how much current and/or power is provided from the solar array circuits 204 to the main power bus. In one embodiment, the current selection circuitry 224 contains switches that each directly connect one of the solar array circuits 204 to the main power bus. The current selection circuitry 224 may also contain switch drivers that may provide an analog voltage to a switch to control. the state of the switch. In one embodiment, the current selection circuitry 224 contains one or more power point trackers (PPT).

The charge current monitor 210 monitors the battery charging current (Ichg), which is provided by the main power bus. As depicted in FIG. 2, the charge current monitor 210 monitors the current that flows from the positive line 214 of the main power bus into the battery 216 by way of the positive terminal 240 of the battery 216. This current may be referred to as a battery charging current (Ichg). However, the charge current monitor 210 could be connected between the negative terminal 242 of the battery 216 and return line 220 of the main power bus in order to monitor the battery charging current (Ichg) that flows from the battery 216 by way of the negative terminal 242 of the battery 216 to the return line 220. The charge current monitor 210 sends a signal to the microcontroller 208 that is indicative of a magnitude of the battery charging current. The charge current monitor 210 sends the signal over a signal line 246. The signal may be a digital or analog signal. The PCDU 206 has a battery interface 254 (having a positive connection 254a and a negative connection 254b) that provides the battery charging current (Ichg) to the battery 216. Herein, the term “battery interface” may be used to refer to the interface to the main power bus that the PCDU 206 provides to the battery 216. In an embodiment, the positive connection 254a of the battery interface allows the positive terminal 240 of the battery to be connected to the charge current monitor 210. In an embodiment, the negative connection 254b of the battery interface allows the negative terminal 240 of the battery to be connected to the return line 220. a portion of which resides inside the PCDU 206. In an embodiment, the negative connection 254b of the battery interface allows the negative terminal 240 of the battery to be connected to the charge current monitor 210, if the charge current monitor 210 is located differently than in FIG. 2. In one embodiment, rather than connecting the negative terminal 242 of the battery 216 to the negative connection 254b of the PCDU 206, both the PCDU 206 and the negative terminal 242 of the battery 216 are connected to ground 222, which may be considered to be part of the battery interface. Therefore, negative connection 254b is optional.

The battery voltage monitor 212 monitors the voltage that is between the terminals 240, 242 of the battery 216. This voltage may be referred to as the battery voltage. The battery voltage monitor 212 sends a signal to the microcontroller 208 that is indicative of a magnitude of the battery voltage. The battery voltage monitor 212 sends the signal over a signal line 248. The signal may be a digital or analog signal. Although FIG. 2 depicts the battery voltage as being measured at terminals 240 and 242, which are external to the PCDU 206, the battery voltage monitor 212 could measure the battery voltage at nodes within the PCDU 206. For example, because the negative terminal 242 of the battery is connected to a portion of the return line 220 that is located within the PCDU 206, the voltage of the negative side of the battery 216 could be monitored from a physical point on return line 220 within the PCDU 206. Similarly, because the positive terminal 240 of the battery 216 is connected to the positive line 214c and 214a, the voltage of the positive side of the battery 216 could also be monitored at a physical point within the PCDU 206 somewhere on positive line 214a or 214c.

The PCDU 206 has an external data interface 258 that connects to a data bus 250. An example of the external data interface 258 is an RS-232 interface. The microcontroller 208 is connected to the data interface 258 and thus the data bus 250, which may be in communication with a main computer 260 on the spacecraft 102. The main computer 260 may be configured to execute a main flight program. The main computer 260 may output a set of battery charging parameters over the data bus 250 to the microcontroller 208. The set of battery charging parameters may include, but are not limited to, one or more target battery charging currents and a target battery voltage. A target battery charging current is the target magnitude for Ichg. The magnitude of the target battery charging current can change during the battery charging process. For example, the target battery charging current can be greater when then battery voltage is lower, and reduced when the battery voltage is greater. In one embodiment, the battery charging parameters define the magnitude of the battery voltage at which the target charging current should be reduced. The target battery voltage is the voltage to which the battery 216 is to be charged. In one embodiments, target battery voltage depends on the age of the battery 216. For example, the target battery voltage may increase as the battery ages.

The microcontroller 208 is configured to control current selection circuity 224 in order to provide a load current and/or power to the load 218 and the target charging current to the battery 216. Thus, the microcontroller 208 will control the current selection circuity 224 to maintain the battery charging current at the target charging current. In an embodiment, the microcontroller 208 sends control signals over a set of control lines 244 between the microcontroller 208 and the current selection circuity 224. The control signals may be digital or analog signals. In an embodiment, the control signals are digital signals.

In an embodiment, a first set of the solar array circuits 204 are directly connected to the main power bus. For example, respective switches in the current selection circuity 224 may be closed to directly connect a first set of the solar array circuits 204 to the positive line 214 of the main power bus. The respective switches associated with a second set of the solar array circuits 204 are opened such that the second set of the solar array circuits 204 are disconnected from the main power bus. Thus, there is an open circuit between a solar array circuit 204 in the second set and the main power bus. The microcontroller 208 changes the number of solar array circuits 204 in the first and second sets to regulate the current and/or power provided by the solar array 104.

In an embodiment, the microcontroller 208 is programmable and reprogrammable. In one embodiment, microcontroller 208 is programmable by software. In other embodiments, the programmable and reprogrammable microcontroller 208 does not use software and is completely implemented in hardware (e.g., electrical circuits). The microcontroller 208 may comprise one or more processors that process and/or execute microcode or other computer executable code (e.g., an instruction set) to perform tasks or operations. In an embodiment, the microcontroller 208 executes instructions on a processor (e.g., microprocessor). These processor executable instructions may be stored in non-transitory, storage. The non-transitory storage could be volatile memory or non-volatile memory. Examples of volatile memory include, but are not limited to, DRAM and SRAM. Example of non-volatile memory include, but are not limited to, EEPROM and Flash (e.g., NAND, NOR). The non-transitory storage may reside within the PCDU 206 or be external to the PCDU 206. In an embodiment, the microcontroller 208 is able to perform additional tasks for functions of the PCDU 206 such as command processing and telemetry.

The main computer 260 may comprise one or more processors that process and/or execute microcode or other computer executable code (e.g., an instruction set) to perform tasks or operations. The computer executable code may be stored in non-transitory storage.

In an embodiment, the PCDU 206 includes one or more interface cards. An interface card has one or more interfaces. The PCDU 206 has a solar array interface 230 and a battery interface 232. The solar array interface 230 has a number of solar array circuit inputs 230-1, 230-2, . . . 230-n with each solar array circuit input configured to receive a current from a different solar array circuit 204. Each solar array circuit input 230 provides a physical and electrical connection to one of the solar array circuits 204. For example, input 230-1 is configured to receive a current from solar array circuit 204-1, input 230-2 is configured to receive a current from solar array circuit 204-2, and input 230-n is configured to receive a current from solar array circuit 204-n.

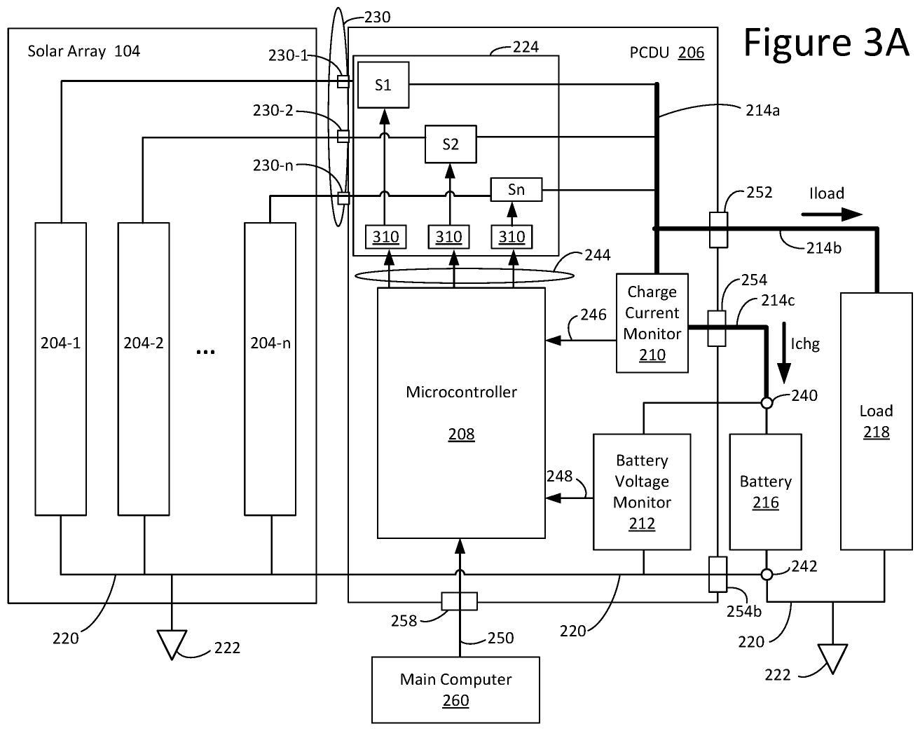

In one embodiment, the PCDU 206 has a direct energy transfer (DET) architecture. FIG. 3A is a diagram of one embodiment of a DET architecture in which the energy from the respective solar array circuits 204 is directly transferred to the main power bus. In FIG. 3A, the current selection circuitry 224 is implemented with a number of switches S1-Sn and switch drivers 310. There is one switch for each solar array circuit 204. Each switch is connected between one of the solar array circuits 204 and the positive line 214 of the main power bus. Alternatively, the switches S1, S2, . . . Sn could be located between the solar array circuits 204 and the return line 220 of the main power bus. Each switch has an open state and a closed state. In the closed state the switch will electrically connect its associated solar array circuit 204 to the main power bus. That is, when the switch is closed, the associated solar array circuit 204 will be electrically connected between the positive line 214 and the negative line 220 of the main power bus. in the open state the switch will disconnect its associated solar array circuit 204 from the main power bus. in other words, the open switch will create an open circuit between the solar array circuit 204 and either the positive line 214 or return line 220. In one embodiment, each switch S1-Sn has (or is) a transistor such as a MOSFET. in one embodiment, each switch S1-Sn has (or is) a relay, that can be opened or closed. The microcontroller 208 is configured to control the switches S1-Sn by issuing control signals to switch drivers 310. The switch drivers 310 send a control signal to the respective switches S1-Sn to control the state of the switch. As one example, each switch is a MOSFET and the associated switch driver 310 sends an analog voltage to either turn the MOSFET on (closed state) or off (open state).

The microcontroller 208 is configured to control the switches S1-Sn to connect a first set of the solar array circuits 204 in parallel to the main power bus and disconnect a second set of the solar array circuits 204 from the main power bus in order to provide power, voltage, and/or a load current to the load 218 and the target charging current to the battery 216. Thus, the microcontroller 208 will control the switches S1-Sn to maintain the battery charging current at the target charging current. In an embodiment, the microcontroller 208 sends control signals over a set of control lines 244 between the microcontroller 208 and the switch drivers 310. The control signals may be digital or analog signals.

In an embodiment, the first set of the solar array circuits 204 are directly connected to the main power bus. For example, the respective switches associated with first set of the solar array circuits 204 are closed to directly connect the first set of the solar array circuits 204 to the positive line 214 of the main power bus. The respective switches associated with second set of the solar array circuits 204 are open such that the second set of the solar array circuits 204 are disconnected from the main power bus. Thus, there is an open circuit between a solar array circuit 204 in the second set and the main power bus.

In one embodiment, the PCDU 206 has a Power Point Tracker (PPT) architecture. FIG. 3B depicts an embodiment in which the PCDU 206 has a PPT architecture. In FIG. 3B, the current selection circuitry 224 is implemented with a number of PPTs 324-1, 324-2, . . . 324-n. In one embodiment, the PPT is a Peak Power Point Tracker. In one embodiment, the PPT is a Maximum Power Point Tracker. In the embodiment of FIG. 3B there is one PPT 324 per each solar array circuit 204. In another embodiment, there is a single PPT for all of the solar array circuits 204. The microcontroller 208 sends a control signal to each PPT 324 to control how much current and/or power is provided by each solar array circuits 204 to the main power bus. In one embodiment, the signals are digital signals but each PPT will convert the digital signal to an analog voltage. For example, the magnitude of the analog voltage may control how much current and/or power is provided to the main power bus.

FIG. 4 is diagram of one embodiment of a solar array circuit 204. The solar array circuit 204 has a number of PV modules 402 that are connected together. Each PV module 402 has at least one PV cell. A PV module 402 typically contains a number of PV cells connected together in series and/or parallel. Connecting a number of PV cells in series allows for a greater voltage to be provided by the solar array. Herein, a string of series connected PV cells will be referred to as a PV cell string. Connecting a number of PV cell stings in parallel allows for a greater current to be provided by the solar array. It is common for PV cells to be packaged in a PV module 402 that contains a number of PV cells. Each PV module 402 typically contains at least one PV cell string. Multiple PV cell strings can be connected in parallel within the PV module 402 to increase the current output of the PV module 402.

Each PV cell may also be referred to as a solar cell. The PV cell is an electrical device that converts light into electricity by the photovoltaic effect. Each PV cell may contain one or more semiconductor diodes (i.e., one or more pn junctions). Thus, each PV cell may be a single junction semiconductor device or a multi junction semiconductor device. An example is a III-V semiconductor multi junction device, where each junction has a different band gap energy to enable absorption of electromagnetic radiation over a different range of wavelengths. Other types of materials may be used in the PV cell.

Each PV module 402 has two terminals in the example in FIG. 4. The PV module 402 may be viewed as the fundamental building block of a solar array. A number of PV modules 402 are connected in series to form a PV module string 404. FIG. 4 depicts PV module strings 404-1, 404-2, . . . 404-m connected in parallel. The PV module strings 404-1, 404-2, . . . 404-m are connected together at a bottom end 410. The PV module strings 404-1, 404-2, . . . 404-m are connected together at a top end 412. Thus, the currents from the PV module strings 404-1, 404-2, . . . 404-m will sum together to form a current output of the solar array circuit 204. Multiple solar array circuit 204 can be connected together to form a solar array. For example, multiple solar array circuit 204 can be connected in parallel in order to increase the current output. As another example, multiple solar array circuit 204 can be connected in series in order to increase the voltage output.

Moreover, the PV module strings 404-1, 404-2, . . . 404-m are connected in parallel across the main power bus (when connected to the main power bus). Because the PV module strings 404-1, 404-2, . . . 404-m are connected at both ends 410, 412 they are selected as a unit (when the solar array circuit 204 is selected). Moreover, when the solar array circuit 204 is selected, in an embodiment, a closed circuit is formed in which the top end 412 of the solar array circuit 204 is connected to the positive line 214 of the main power bus and the bottom end 410 of the solar array circuit 204 is connected to the return line 220 of the main power bus. Although the solar array circuit 204 in FIG. 4 has a number of PV module strings 404 (i.e., m PV module strings 404), in one embodiment, the solar array circuit 204 has a single PV module string 404.

There may be a number of protection diodes in the solar array circuit 204. One possible type of protection diode protects against reverse current in each respective PV module string 404. Such a diode is sometimes referred to as a blocking diode 411, which is depicted near the top end 412 of each respective PV module string 404. The blocking diodes 411 will protect against current flowing from the top end 412 to the bottom end 410. Another possible type protection diode protects against forward current in a PV module 402 that is not presently generating current. Such a diode is sometimes referred to as a bypass diode. A bypass diode may be placed in parallel with each PV module 402, which allows current flowing from the bottom end 410 to the top end 412 to bypass the PV module 402. PV module 402 in a string 404 that are exposed to sunlight will generate a current. However, if one of the PV modules 402 in the string 404 is not exposed to sufficient sunlight it will not generate significant current. The bypass diode allows current to bypass such as “shaded” PV module 402. In an embodiment, each PV module 402 has a bypass diode integrated in the module. The solar array circuits 204 are not limited to the example depicted in FIG. 4.

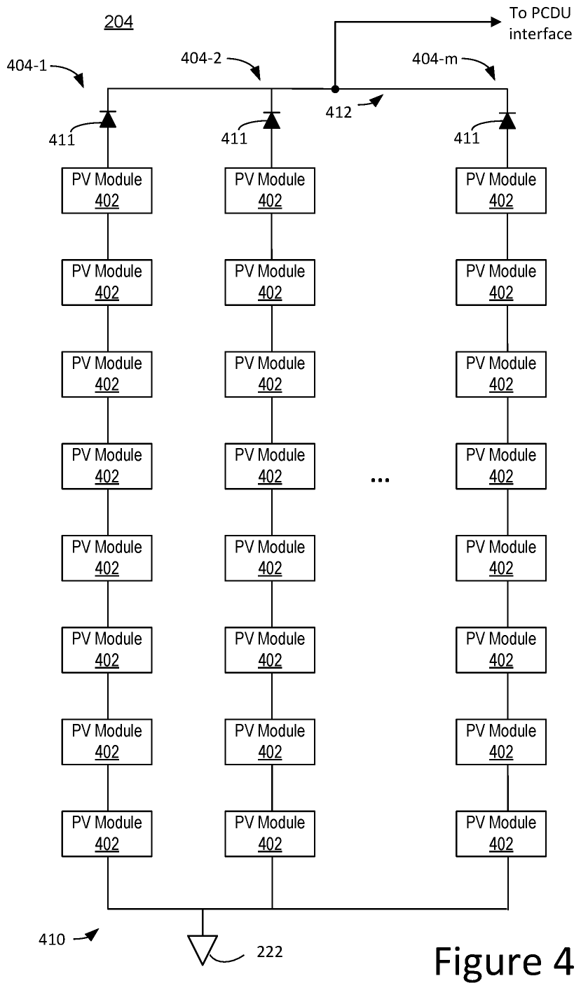

FIG. 5 is a flowchart of one embodiment of a process 500 of charging a battery in a spacecraft. In one embodiment, the process is controlled by microcontroller 208. Step 502 includes the microcontroller 208 within a PCDU 206 of a spacecraft 102 monitoring a battery charging current (Ichg) provided from a main power bus 214c to a battery 216 connected to a battery interface 254 of the PCDU 206 in the spacecraft. In an embodiment, the charge current monitor 210 will sense Ichg and send a signal indicative of a magnitude of the battery charging current over signal line 246 to the microcontroller 208 such that microcontroller 208 monitors the battery charging current (Ichg). The signal may be a digital or analog signal.

Step 504 includes the microcontroller 208 monitoring a voltage of the battery 216. In an embodiment, the battery voltage monitor 212 will sense the voltage between the positive terminal 240 and the negative terminal 242 of the battery and send a signal indicative of a magnitude of the battery voltage over signal line 248 to the microcontroller 208 such that microcontroller 208 monitors the battery voltage. The signal may be a digital or analog signal.

Step 506 includes the microcontroller 208 controlling the current selection circuitry 224 in the PCDU 206 to in order to provide a load current (Iload) to a load 218 and a target charging current to the battery 216. In one embodiment, the microcontroller 208 receives a signal over the data bus 250 that indicates the magnitude of the target charging current. The signal may be provided by a main computer 260. In one embodiment, the main computer 260 executes a main flight program for the spacecraft 102. Step 506 may be performed while charging the battery 216 to a target battery voltage. In one embodiment, the microcontroller 208 receives a signal over the data bus 250 that indicates the magnitude of the target battery voltage.

Steps 502-506 are then repeated. When steps 502 and 504 are performed a new data sample for the battery charging current and the battery voltage are provided to the microcontroller 208. Thus, the magnitudes of the battery charging current and the battery voltage are monitored at different points in time. The time gap between each data sampling can be the same, or the time gaps can vary. Note that the target charging current may change during step 506. In one embodiment, the magnitude of the target charging current is modified based on the battery voltage that is sensed in step 504.

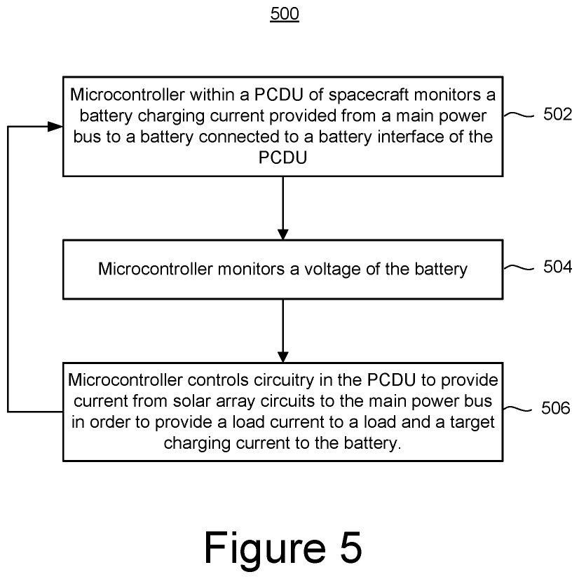

FIG. 6 is a flowchart of one embodiment of a process 600 of charging a battery in a spacecraft by a microcontroller within a PCDU 206 having a DET architecture. In one embodiment, the process is controlled by microcontroller 208. In one embodiment, process 600 is used within a PCDU 206 having a DET architecture, such as in FIG. 3A. Step 602 includes the microcontroller 208 within a PCDU 206 of a spacecraft 102 monitoring a battery charging current (Ichg) provided from a main power bus 214c to a battery 216 connected to a battery interface 254 of the PCDU 206. In an embodiment, the charge current monitor 210 will sense Ichg and send a signal indicative of a magnitude of the battery charging current over signal line 246 to the microcontroller 208 such that microcontroller 208 monitors the battery charging current (Ichg).

Step 604 includes the microcontroller 208 monitoring a voltage of the battery 216. In an embodiment, the battery voltage monitor 212 will sense the voltage between the positive terminal 240 and the negative terminal 242 of the battery and send a signal indicative of a magnitude of the battery voltage over signal line 248 to the microcontroller 208 such that microcontroller 208 monitors the battery voltage.

Step 606 includes the microcontroller 208 controlling switches S1-Sn in the PCDU 206 to connect a first set of solar array circuits 204 in parallel to the main power bus and disconnect a second set of the solar array circuits 204 from the main power bus in order to provide a load current (Iload) to a load 218 and a target charging current to the battery 216. In one embodiment, the microcontroller 208 receives a signal over the data bus 250 that indicates the magnitude of the target charging current. The signal may be provided by a main computer 260. In one embodiment, the main computer 260 executes a main flight program for the spacecraft 102. Step 606 may be performed while charging the battery 216 to a target battery voltage. In one embodiment, the microcontroller 208 receives a signal over the data bus 250 that indicates the magnitude of the target battery voltage.

Steps 602-606 are then repeated. When steps 602 and 604 are performed a new data sample for the battery charging current and the battery voltage are provided to the microcontroller 208. Thus, the magnitudes of the battery charging current and the battery voltage are monitored at different points in time. The time gap between each data sampling can be the same, or the time gaps can vary. In step 606, the microcontroller 208 may adjust a first number of solar array circuits 204 in the first set and a second number of solar array circuits 204 in the second set to maintain the battery charging current (Ichg) at the target charging current. Note that the target charging current may change during step 606. In one embodiment, the magnitude of the target charging current is modified based on the battery voltage that is sensed in step 604.

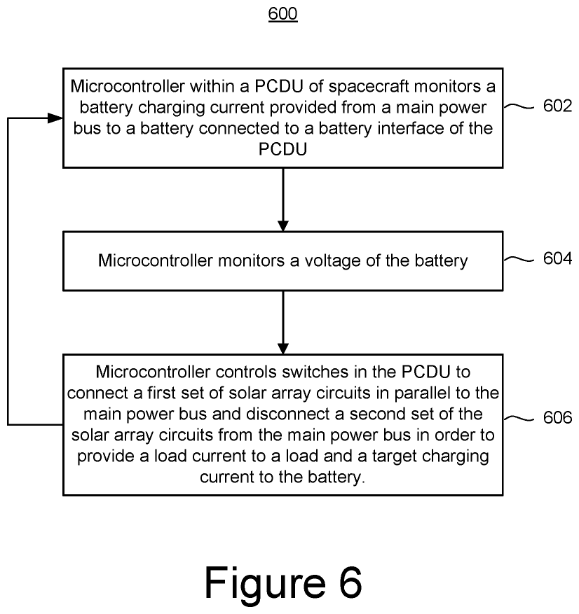

FIG. 7 is a flowchart of one embodiment of a process 700 of the microcontroller 208 determining how to control the current selection circuitry 224. Process 700 provides further details of an embodiment of process 500. In an embodiment, process 700 includes the microcontroller 208 executing instructions on a processor (e.g., microprocessor). The microcontroller 208 may access these processor executable instructions from non-transitory storage.

Step 702 includes the microcontroller 208 accessing the latest data sample for the charge current and the battery voltage. Step 704 includes the microcontroller 208 comparing the present battery voltage to a target battery voltage. If the present battery voltage is not less than a target battery voltage, then charging of the battery is not necessary. Thus, in step 706 the microcontroller 208 determines whether the present charging current is greater than zero. If the present charging current greater than zero then in step 708 the microcontroller 208 controls the current selection circuitry 224 to reduce the charge current towards zero. In an embodiment, the microcontroller 208 determines how many of the solar array circuits 204 should be connected to the main power bus in order to provide the present load current. The microcontroller 208 may determine how many of the switches that are presently closed should be opened in order to reduce the charge current to zero. After updating the control signals to the current selection circuitry 224 (e.g., switches S1-Sn), the process 700 returns to step 702 to obtain the next data samples. Returning to the discussion of step 706 if the present charge current is not greater than zero then process 700 returns to step 702 to obtain the next data samples. Note that the charge current could be negative, which indicates that the battery 216 is presently providing current to the load. If the charge current is negative at step 706, one option is for the microcontroller 208 to increase the current provided by the current selection circuity 224 (e.g., close one or more switches S1-Sn) to provide more current from the solar array so as to not drain the battery.

Returning to the discussion of step 704, if the battery voltage is less than the target then the microcontroller 208 determines in step 710 whether the battery voltage is within a threshold of a target battery voltage. In an embodiment, the threshold is provided by the main computer 260. This determination is made so as to determine whether the target charging current should be changed. Hence, the target charging current may be based on the present battery voltage. If the battery voltage is not within the threshold of the target battery voltage then, in step 712, the microcontroller 208 controls the current selection circuitry 224 (e.g., switches S1-Sn) to move the charging current towards the default target charging current. In an embodiment, the default target charging current is provided by the main computer 260. Step 712 may include the microcontroller 208 adjusting the number of solar array circuits 204 connected to the main power bus. After step 712 the process 700 returns to step 702 to access the next data samples.

If the battery voltage is within the threshold of the target battery voltage then, in step 714, the microcontroller 208 controls the current selection circuitry 224 (e.g., switches S1-Sn) to move the charging current towards a trickle charging current (which is a modified value for the target charging current). The trickle charging current is significantly smaller than the default target charging current. In an embodiment, the trickle target charging current is provided by the main computer 260. However, the trickle target charging current is not required to be provided by the main computer 260. Step 714 may include the microcontroller 208 adjusting the number of solar array circuits 204 connected to the main power bus. After step 714 the process 700 returns to step 702 to access the next data samples.

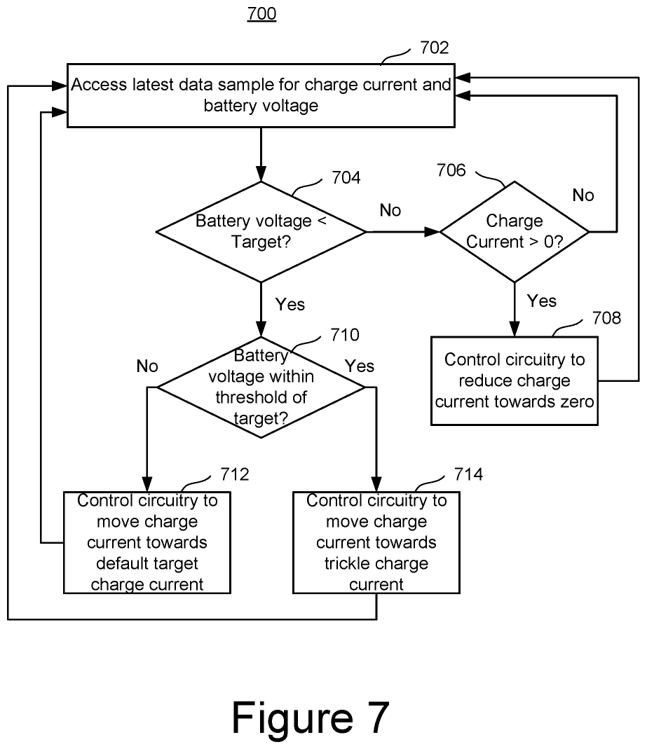

FIG. 8 is a flowchart of one embodiment of a flowchart of a process 800 of controlling switches to achieve a target battery charging current. Process 800 may be used in one embodiment of step 506 in FIG. 5. Process 800 may be used in one embodiment of step 606 in FIG. 6. Process 800 may be used in one embodiment of step 712 or 714 in FIG. 7. Inputs to the process 800 include the target charging current and the latest data sample for the charge current. In one embodiment, the target charging current is a default charging current, which may be provided to the microcontroller 208 over external data bus 258. In one embodiment, the target charging current is a trickle charging current, which may be provided to the microcontroller 208 over external data bus 258. In some embodiments, the values for the default charging current and/or the trickle charging current are not provided over the external data bus 258. Instead the microcontroller 208 accesses these values from memory, which could be internal to PCDU 206 or external to PCDU 206.

Step 802 includes the microcontroller 208 comparing the latest data sample for the charge current to the target charging current. If the battery charging current (Ichg) is less than the target charging current, then in step 804 the microcontroller 208 closes one or more switches S1-Sn that were previously open. Switches that were already closed remain closed. The number of switches that are closed may depend on the difference between the battery charging current (Ichg) and the target charging current.

If the battery charging current (Ichg) is greater than the target charging current, then in step 806 the microcontroller 208 opens one or more switches S1-Sn that were previously closed. Switches that were already open remain open. The number of switches that are opened may depend on the difference between the battery charging current (Ichg) and the target charging current. Note that step 806 may also be used in an embodiment of step 708 of FIG. 7, where the target charging current is zero Amperes.

If the battery charging current (Ichg) is equal to the target charging current, then in step 808 the microcontroller 208 determines that no changes are made to the states of the switches S1-Sn. In an embodiment, the battery charging current (Ichg) is considered to be equal to the target charging current if the battery charging current (Ichg) is within a window of the target charging current.

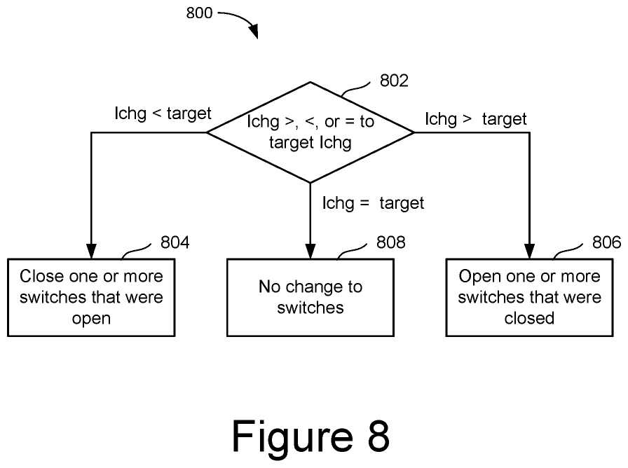

In some embodiments, the microcontroller 208 receives battery charging parameters from a main computer external to the PCDU 206. FIG. 9 is a flowchart of one embodiment of a process 900 of the microcontroller 208 controlling spacecraft battery charging based on battery charging parameters received from the main computer. Step 902 includes the microcontroller 208 in the PCDU 206 receiving charge control parameters over the external data bus 250 from the main computer 260 of the spacecraft. The main computer 260 may be configured to execute a main flight program for the spacecraft. The charging parameters may be determined based on the execution of the main flight program. In this manner, the battery charging parameters can be adapted to suit varying conditions that may occur during the mission of the spacecraft 102. Step 904 includes the microcontroller 208 determining control signals to issue to the current selection circuitry 224 (e.g., switches S1-Sn) in the PCDU 206 based on the battery charging parameters.

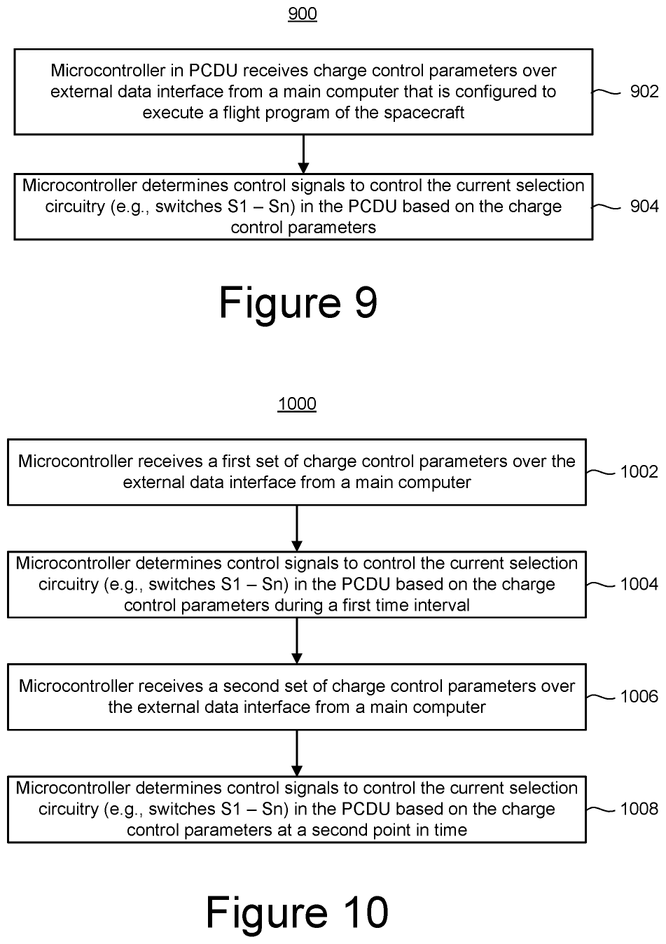

Because the microcontroller 208 receives the battery charging parameters from the main computer (or other source over the data bus 250), the manner in which the battery is charged can be changed to adapt to varying conditions. FIG. 10 is a flowchart of one embodiment of a process 1000 of the microcontroller 208 varying the battery charging process based on changes (or updates) to battery charging parameters. Step 1002 includes the microcontroller 208 in the PCDU 206 receiving a first set of charge control parameters over the external data bus 250 from the main computer 260 of the spacecraft 102. Step 1004 includes the microcontroller 208 determining control signals to issue to the current selection circuitry 224 (e.g., switches S1-Sn) in the PCDU 206 based on the battery charging parameters during a first time interval. Step 1006 includes the microcontroller 208 in the PCDU 206 receiving a second set of charge control parameters over the external data bus 250 from the main computer 260. Step 1008 includes the microcontroller 208 determining control signals to issue to the current selection circuitry 224 (e.g., switches S1-Sn) in the PCDU 206 based on the battery charging parameters during a second time interval. Thus, process 1000 allows the charging of the battery to easily be modified by sending new (or updated) charging parameters to the microcontroller 208.

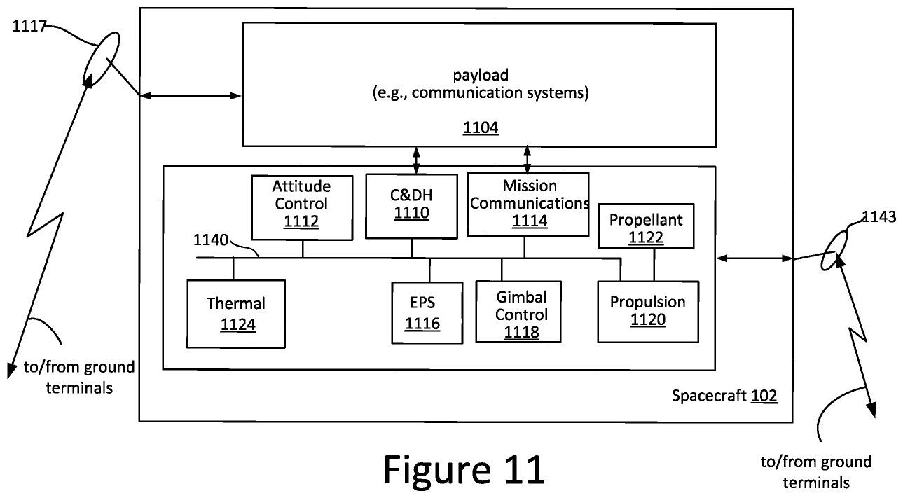

FIG. 11 is block diagram of one embodiment of spacecraft 102, which in one example (as discussed above) is a satellite. In one embodiment, spacecraft 102 a payload 1104, various sub-systems and an EPS 1116. Some embodiments of spacecraft 102 may include more than one payload. The payload provides the functionality of communication, sensors and/or processing systems needed for the mission of spacecraft 102.

EPS (Electrical Power Subsystems) 1116 can include one or more solar panels and charge storage (e.g., one or more batteries) used to provide power to spacecraft 102. Power subsystems 1116 also includes a PCDU 206. The PCDU 206 of the EPS 1116 provide power to the main power bus 1140. The main power bus 1140 is connected to various sub-systems, which are part of the load 218. The main power bus 1140 may also provide power to the payload 1104, which may also be part of the load 218.

Each of the functional subsystems typically include electrical systems, as well as mechanical components (e.g., servos, actuators) controlled by the electrical systems. These include a command and data handling subsystem (C&DH) 1110, attitude control systems 1112, mission communication systems 1114, gimbal control electronics 1118 that be taken to include a solar array drive assembly, a propulsion subsystem 1120 (e.g., thrusters), propellant storage 1122 to fuel some embodiments of propulsion subsystem 1120, and thermal control subsystem 1124, all of which are connected by an internal communication network, which can be an electrical bus (a “flight harness”) or other means for electronic, optical or RF communication when spacecraft is in operation. In an embodiment, a main computer 260 may be used to implement one or more of the subsystems.

Also represented are an antenna 1143, that is one of one or more antennae used by the mission communication systems 1114 for exchanging communications for operating of the spacecraft with ground terminals, and a payload antenna 1117, that is one of one or more antennae used by the payload 1104 for exchanging communications with ground terminals, such as the antennae used by a communication satellite embodiment. Other equipment can also be included.

The command and data handling module 1110 includes any processing unit or units for handling includes command control functions for spacecraft 102, such as for attitude control functionality and orbit control functionality. The attitude control systems 1112 can include devices including torque rods, wheel drive electronics, and control momentum gyro control electronics, for example, that are used to monitor and control the attitude of the spacecraft. Mission communication systems 1114 includes wireless communication and processing equipment for receiving telemetry data/commands, other commands from the ground control terminal 30 to the spacecraft and ranging to operate the spacecraft. Processing capability within the command and data handling module 1110 is used to control and operate spacecraft 102. An operator on the ground can control spacecraft 102 by sending commands via ground control terminal 30 to mission communication systems 1114 to be executed by processors within command and data handling module 1110. In one embodiment, command and data handling module 1110 and mission communication system 1114 are in communication with payload 1104. In some example implementations, bus 1102 includes one or more antennae as indicated at 1143 connected to mission communication system 1114 for wirelessly communicating between ground control terminal 30 and mission communication system 1114.

Propulsion subsystem 1120 (e.g., thrusters) is used for changing the position or orientation of spacecraft 102 while in space to move into orbit, to change orbit or to move to a different location in space. The gimbal control electronics 1118 can be used to move and align the antennae, solar panels, and other external extensions of the spacecraft 102.

In one embodiment, the payload 1104 is for a communication satellite and includes an antenna system (represented by the antenna 1117) that provides a set of one or more beams (e.g., spot beams) comprising a beam pattern used to receive wireless signals from ground stations and/or other spacecraft, and to send wireless signals to ground stations and/or other spacecraft. In some implementations, mission communication system 1114 acts as an interface that uses the antennae of payload 1104 to wirelessly communicate with ground control terminal 30. In other embodiments, the payload could alternately or additionally include an optical payload, such as one or more telescopes or imaging systems along with their control systems, which can also include RF communications to provide uplink/downlink capabilities.

A first embodiment includes a power control and distribution unit (PCDU) for a spacecraft. The PCDU comprises a main power bus, a solar array interface, a battery interface configured to connect a battery to the main power bus, a main power bus interface configured to provide a load current from the main power bus to a load, current selection circuitry, and a programmable and reprogrammable microcontroller in communication with the battery interface and the current selection circuitry. The solar array interface has a plurality of solar array circuit inputs with each solar array circuit input configured to receive a solar array circuit current from a different solar array circuit of the spacecraft. Each solar array circuit comprising a plurality of photovoltaic (PV) cells connected to provide the solar array circuit current. The current selection circuitry is connected between the solar array circuit inputs and the main power bus. The current selection circuitry is configured to provide solar array circuit current from the respective solar array circuits to the main power bus. The microcontroller is configured to control the current selection circuitry to provide the load current to the load and a battery charging current to the battery. The microcontroller is configured to receive, at a plurality of points in time, a first signal indicative of a magnitude of the battery charging current and a second signal indicative of a battery voltage across the battery. The microcontroller is configured control, at the different points in time, the current selection circuitry to maintain the battery charging current at a target charging current while charging the battery to a target battery voltage.

In a second embodiment in furtherance of the first embodiment, the PCDU further comprises an external data interface in communication with the microcontroller. The microcontroller is configured to receive charge control parameters over the external data interface, and control the current selection circuitry based on the charge control parameters.

In a third embodiment in furtherance of the second embodiment, the microcontroller is configured to receive a first set of charge control parameters from the external data interface, control the current selection circuitry during a first time interval based on the first set of charge control parameters, receive a second set of charge control parameters from the external data interface, and control the current selection circuitry during a second time interval based on the second set of charge control parameters.

In a fourth embodiment, in furtherance of any of the second to third embodiments, the microcontroller is configured to receive the target charging current over the external data interface from a main computer that is configured to execute a flight program of the spacecraft. The microcontroller is configured to receive the target battery voltage over the external data interface from the main computer.

In a fifth embodiment, in furtherance of any of the first to fourth embodiments, the microcontroller is configured to modify the target charging current based on the battery voltage.

In a sixth embodiment, in furtherance of any of the first to fifth embodiments, the microcontroller is configured to reduce the battery charging current to a trickle current responsive to the second signal indicating that the battery voltage is within a threshold of the target battery voltage.

In a seventh embodiment, in in furtherance of any of the first to sixth embodiments, the current selection circuitry comprises a plurality of switches. Each switch is connected between one of the solar array circuits and the main power bus. Each switch has a closed state to electrically connect a respective solar array circuit to the main power bus and an open state to create an open circuit between the respective solar array circuit and the main power bus. The microcontroller is configured to control the switches to connect a first set of the solar array circuits in parallel to the main power bus and disconnect a second set of the solar array circuits from the main power bus in order to provide the load current to the load and maintain the battery charging current to the battery at the target charging current.

In an eighth embodiment, in furtherance of the seventh embodiment, each of the plurality of switches comprises a transistor configured to directly connect the respective solar array circuit to the main power bus.

In a ninth embodiment, in furtherance of the seventh embodiment, each of the plurality of switches comprises a relay configured to directly connect the respective solar array circuit to the main power bus.

In a tenth embodiment, in furtherance of the seventh embodiment, the microcontroller is configured to increase a number of the solar array circuits in the first set responsive to an increase in the load current in order to maintain the battery charging current at the target charging current.

In a eleventh embodiment, in furtherance of any of the first to tenth embodiments, the current selection circuitry comprises one or more Power Point Tracker (PPT). The microcontroller is configured to control the one or more PPTs to provide the load current to the load and maintain the battery charging current to the battery at the target charging current.

One embodiment includes a method for charging a battery in a spacecraft. The method comprises monitoring, by a programmable and reprogrammable microcontroller within a power control and distribution unit (PCDU) of the spacecraft, a battery charging current provided from a main power bus of the PCDU to a battery connected to a battery interface of the PCDU. The PCDU has a solar array interface having a plurality of solar array circuit inputs with each solar array circuit input configured to receive a current from a different solar array circuit. The PCDU has a main power bus interface configured to provide a load current from the main power bus to a load. The method comprises monitoring, by the microcontroller, a voltage of the battery. The method comprises controlling, by the microcontroller, switches in the PCDU to connect a first set of the solar array circuits in parallel to the main power bus and disconnect a second set of the solar array circuits from the main power bus in order to provide the load current to the load and a battery charging current to the battery while charging the battery to a target battery voltage. The method comprises repeating the monitoring of the battery charging current, the monitoring of voltage of the battery, and the controlling of the switches to adjust a first number of solar array circuits in the first set and a second number of solar array circuits in the second set to maintain the battery charging current at a target charging current while charging the battery to the target battery voltage.

One embodiment includes a spacecraft comprising a main computer configured to execute a flight program, a plurality of solar array circuits, a battery, one or more sub-systems, and a power control and distribution unit (PCDU). The main computer is configured to output a set of battery charging parameters in response to execution of the flight program. The set of battery charging parameters include a target charging current and a target battery voltage. Each solar array circuit is configured to provide a current. The PCDU has a data interface in communication with the main computer, a main power bus connected to the one or more sub-systems and configured to provide a load current to the one or more sub-systems, a plurality of switches and a microprocessor in communication with the battery and the plurality of switches. Each switch is connected between one of the solar array circuits and the main power bus. Each switch has a closed state to electrically connect a respective solar array circuit to the main power bus and an open state to create an open circuit between the respective solar array circuit and the main power bus. The microprocessor is configured to receive the set of battery charging parameters over the data interface from the main computer. The microprocessor is configured to monitor a battery charging current provided by the main power bus to the battery. The microprocessor is configured to monitor a battery voltage across the battery. The microprocessor is configured to control the switches to order to provide the load current to the load and the battery charging current to the battery while charging the battery to the target battery voltage, including: provide a first control signal to each switch in a first set of the switches to close the switches to connect a first set of the solar array circuits in parallel to the main power bus; provide a second control signal to each switch in a second set of the switches to open the switches to create an open circuit between a second set of the solar array circuits and the main power bus; and adjust a first number of switches in the first set and a second number of switches in the second set to maintain the battery charging current at the target charging current while charging the battery to the target battery voltage.

For purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope of be defined by the claims appended hereto.

What is claimed is:

1. A power control and distribution unit (PCDU) for a spacecraft, the PCDU comprising:
a main power bus;
a solar array interface, the solar array interface having a plurality of solar array circuit inputs with each solar array circuit input configured to receive a solar array circuit current from a different solar array circuit of the spacecraft, each solar array circuit comprising a plurality of photovoltaic (PV) cells connected to provide the solar array circuit current;
a battery interface configured to connect a battery to the main power bus;
a main power bus interface configured to provide a load current from the main power bus to a load;
current selection circuitry connected between the solar array circuit inputs and the main power bus, wherein the current selection circuitry is configured to provide solar array circuit current from the respective solar array circuits to the main power bus; and
a programmable and reprogrammable microcontroller in communication with the battery interface and the current selection circuitry, wherein the microcontroller is configured to:
control the current selection circuitry to provide the load current to the load and a battery charging current to the battery;
receive, at a plurality of points in time, a first signal indicative of a magnitude of the battery charging current and a second signal indicative of a battery voltage across the battery; and
control, at the plurality of points in time, the current selection circuitry to maintain the battery charging current at a target charging current while charging the battery to a target battery voltage.

2. The PCDU of claim 1, further comprising an external data interface in communication with the microcontroller, wherein the microcontroller is configured to:
receive charge control parameters over the external data interface; and
control the current selection circuitry based on the charge control parameters.

3. The PCDU of claim 2, wherein the microcontroller is configured to:
receive a first set of charge control parameters from the external data interface;
control the current selection circuitry during a first time interval based on the first set of charge control parameters;
receive a second set of charge control parameters from the external data interface; and
control the current selection circuitry during a second time interval based on the second set of charge control parameters.

4. The PCDU of claim 2, wherein the microcontroller is configured to:
receive the target charging current over the external data interface from a main computer that is configured to execute a flight program of the spacecraft; and
receive the target battery voltage over the external data interface from the main computer.

5. The PCDU of claim 1, wherein the microcontroller is configured to:
modify the target charging current based on the battery voltage.

6. The PCDU of claim 1, wherein the microcontroller is configured to:
reduce the battery charging current to a trickle current responsive to the second signal indicating that the battery voltage is within a threshold of the target battery voltage.

7. The PCDU of claim 1, wherein:
the current selection circuitry comprises a plurality of switches, each switch connected between one of the solar array circuits and the main power bus, wherein each switch has a closed state to electrically connect a respective solar array circuit to the main power bus and an open state to create an open circuit between the respective solar array circuit and the main power bus; and
the microcontroller is configured to control the switches to connect a first set of the solar array circuits in parallel to the main power bus and disconnect a second set of the solar array circuits from the main power bus in order to provide the load current to the load and maintain the battery charging current to the battery at the target charging current.

8. The PCDU of claim 7, wherein each of the plurality of switches comprises a transistor configured to directly connect the respective solar array circuit to the main power bus.

9. The PCDU of claim 7, wherein each of the plurality of switches comprises a relay configured to directly connect the respective solar array circuit to the main power bus.

10. The PCDU of claim 7, wherein the microcontroller is configured to increase a number of the solar array circuits in the first set responsive to an increase in the load current in order to maintain the battery charging current at the target charging current.

11. The PCDU of claim 1, wherein:
the current selection circuitry comprises one or more Power Point Tracker (PPT); and
the microcontroller is configured to control the one or more PPTs to provide the load current to the load and maintain the battery charging current to the battery at the target charging current.

12. A method for charging a battery in a spacecraft, the method comprising:
monitoring, by a programmable and reprogrammable microcontroller within a power control and distribution unit (PCDU) of the spacecraft, a battery charging current provided from a main power bus of the PCDU to a battery connected to a battery interface of the PCDU, wherein the PCDU has a solar array interface having a plurality of solar array circuit inputs with each solar array circuit input configured to receive a current from a different solar array circuit, wherein the PCDU has a main power bus interface configured to provide a load current from the main power bus to a load;
monitoring, by the microcontroller, a voltage of the battery;
controlling, by the microcontroller, switches in the PCDU to connect a first set of the solar array circuits in parallel to the main power bus and disconnect a second set of the solar array circuits from the main power bus in order to provide the load current to the load and a battery charging current to the battery while charging the battery to a target battery voltage; and
repeating the monitoring of the battery charging current, the monitoring of voltage of the battery, and the controlling of the switches to adjust a first number of solar array circuits in the first set and a second number of solar array circuits in the second set to maintain the battery charging current at a target charging current while charging the battery to the target battery voltage.

13. The method of claim 12, further comprising:
receiving, at an external data interface of the PCDU, charge control parameters from a main computer of the spacecraft; and
controlling, by the microcontroller, the switches based on the charge control parameters.

14. The method of claim 12, further comprising:
receiving, at an external data interface of the PCDU, a first set of charge control parameters from a main computer of the spacecraft;
controlling the switches, by the microcontroller, at a first point in time based on the first set of charge control parameters;
receiving, at the external data interface of the PCDU, a second set of charge control parameters from the main computer; and
controlling the switches, by the microcontroller, at a second point in time based on the second set of charge control parameters.

15. The method of claim 12, wherein adjusting the first number of solar array circuits in the first set and the second number of solar array circuits in the second set to maintain the battery charging current at the target charging current comprises:
increasing the first number of the solar array circuits in the first set connected to the main power bus responsive to an increase in the load current in order to maintain the battery charging current at the target charging current.

16. A spacecraft comprising:
a main computer configured to execute a flight program, wherein the main computer is configured to output a set of battery charging parameters in response to execution of the flight program, wherein the set of battery charging parameters include a target charging current and a target battery voltage;
a plurality of solar array circuits, each solar array circuit configured to provide a current;
a battery;
one or more sub-systems; and
a power control and distribution unit (PCDU) comprising:
a data interface in communication with the main computer;
a main power bus connected to the one or more sub-systems and configured to provide a load current to the one or more sub-systems;
a plurality of switches, each switch connected between one of the solar array circuits and the main power bus, wherein each switch has a closed state to electrically connect a respective solar array circuit to the main power bus and an open state to create an open circuit between the respective solar array circuit and the main power bus; and
a microprocessor in communication with the battery and the plurality of switches, wherein the microprocessor is configured to:
receive the set of battery charging parameters over the data interface from the main computer;
monitor a battery charging current provided by the main power bus to the battery;
monitor a battery voltage across the battery;
control the switches to order to provide the load current to the load and the battery charging current to the battery while charging the battery to the target battery voltage, including:
provide a first control signal to each switch in a first set of the switches to close the switches to connect a first set of the solar array circuits in parallel to the main power bus;
provide a second control signal to each switch in a second set of the switches to open the switches to create an open circuit between a second set of the solar array circuits and the main power bus; and
adjust a first number of switches in the first set and a second number of switches in the second set to maintain the battery charging current at the target charging current while charging the battery to the target battery voltage.

17. The spacecraft of claim 16, wherein the main computer is configured to update the set of battery charging parameters that are provided to the microprocessor in response to execution of the flight program.

18. The spacecraft of claim 16, wherein the microprocessor is configured to modify a magnitude of the target charging current based on a magnitude of the battery voltage.

19. The spacecraft of claim 16, wherein the microprocessor is configured to increase a number of the switches in the first set responsive to an increase in the load current in order to maintain the battery charging current at the target charging current.

20. The spacecraft of claim 16, wherein the microprocessor is configured to:
monitor the battery voltage for an overvoltage; and
reduce the battery charging current to zero responsive to the battery voltage exceeding the overvoltage.
